(19) United States
(12) Patent Application Publication
(10) Pub. No.: US 2022/0103389 A1
(43) Pub. Date: Mar. 31, 2022

(54) System, Device and Method for Facilitating Online Exam Proctoring with Adaptive Accommodations

(71) Applicant: Mind Crawl LLC, Rockville, MD (US)

(72) Inventors: Achal Dua, North Potomac, MD (US); Ekta Kochar, North Potomac, MD (US)

(21) Appl. No.: 17/482,760

(22) Filed: Sep. 23, 2021

Related U.S. Application Data
(60) Provisional application No. 63/083,342, filed on Sep. 25, 2020.

(51) Int. Cl. H04L 12/18; G09B 21/00; G09B 5/12

(52) U.S. Cl. CPC H04L 12/1822; G09B 5/12; G09B 21/009; G09B 21/001

(57) ABSTRACT

Embodiments of a system, device and method facilitate remote proctoring of online examinations for exam takers who may require adaptive accommodations and include suitable programming for verifying identities, verifying physical environments and presenting exam taker display screens in blurred and unblurred modes to a proctor device and an accommodator device, respectively.

### CROSS-REFERENCE TO RELATED APPLICATIONS

The present application claims the priority benefit of U.S. Provisional Patent Application Ser. No. 63/083,342, filed Sep. 25, 2020, the disclosure of which is incorporated by reference herein in its entirety.

### TECHNICAL FIELD

The present disclosure relates to online exam proctoring, and more particularly to the remote proctoring of exam takers who may require adaptive accommodations.

### BACKGROUND AND SUMMARY

In-person proctoring of exams and tests in academic settings is well known. However, the recent surge in online and/or remote learning has presented challenges to effective proctoring. For instance, if a proctor is not physically present with the exam taker during the exam, it can be difficult to ensure that the exam taker is not accessing an information source to improperly assist with answering questions on the exam. For example, an exam taker may view online information sources via a mobile communications device or other computing device, including the computing device through which the exam is being presented, in an effort to cheat on the exam.

At the same time, certain exam takers may require adaptive assistance in order to effectively complete an examination. For example, certain exam takers may have a visual, auditory, physical or other impairment that may prevent seeing, hearing or physically acting in the course of taking an exam. Such individuals may benefit from having human accommodators assist as the individuals during exam taking. Nevertheless, employing a human accommodator increases the challenges of proctoring for online exam takers, as the accommodator adds a complexity that must be technically addressed for effective proctoring to occur.

According to various embodiments, the present disclosure provides a system, device and method for facilitating effective online exam proctoring with adaptive accommodations.

Further aspects are apparent from the description and drawings herein. The computing system(s) associated with the present disclosure can include one or more processors executing instructions stored in one or more memory modules to carry out the requested and required functions disclosed herein.

### BRIEF DESCRIPTION OF THE DRAWINGS

FIG. 1 is an example schematic diagram of a system implemented in part via a media server according to embodiments of the present disclosure.

FIG. 2 is an exemplary user interface in accordance with the present disclosure.

FIG. 3 illustrates a method according to embodiments of the present disclosure.

### DETAILED DESCRIPTION OF EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Example embodiments such as disclosed herein can incorporate a host, local device and/or controller having a processor and an associated memory storing instructions that, when executed by the processor, cause the processor to perform operations as described herein. It will be appreciated that reference to “a”, “an” or other indefinite article in the present disclosure encompasses one or more than one of the described element. Thus, for example, reference to a processor encompasses one or more processors, reference to a memory encompasses one or more memories, reference to an exam taker device encompasses one or more exam taker devices and so forth.

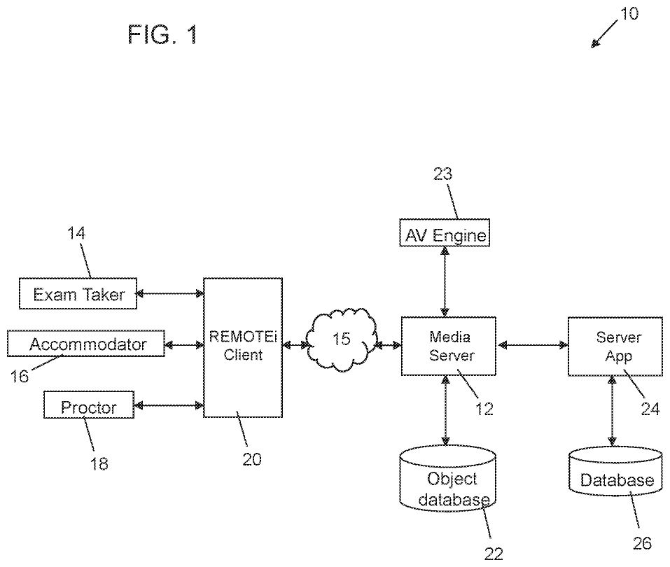

As shown in FIG. 1, a system 10 in accordance with the present disclosure can provide a media server 12 accessible to an exam taker 14, an accommodator 16 and a proctor 18 through a client application (e.g., REMOTEi™ client application) 20 over a network 15. The media server 12 (e.g., REMOTEi™ API backend) can include a processor executing stored programming. In various embodiments, the media server 12 is operable as a website, with different visual interfaces depending upon a user's navigation. The media server 12 can be in communication with an audio/visual engine 23, an object database 22 and a server application 24, wherein the server application is in communication with a host database 26.

In various embodiments, a user can download a software application which is referred to above as the REMOTEi™ client application 20 using known methods. The user's computing device can operate software to install the application once downloaded. It will be appreciated that the application can be compatible with Mac™, Windows™ and Linux™ operating systems. The download can contain an installation package, which when selected commences an unpacking and installation of the application. In various embodiments, this will open a pop-up window to advise of the installation process, which will look slightly different based on the operating system (e.g., Windows™, Mac™, etc.) of the end user. The REMOTEi™ client application can also be provided as a cloud-based service without being stored locally on a client device, according to various embodiments of the present disclosure.

Different parties can log in to the media server using the REMOTEi™ client application 20, including test takers, accommodators and proctors. In various embodiments, a test taker may be shown three text boxes on the login page for the test taker to enter their first and last name, as well as a token number. The first and last name will be that of the test taker sitting an exam. The token number will be a unique code provided by the media server 12 for use in a specific exam. In various embodiments, the token number is determined when the exam is created. The user can enter this token number/code in conjunction with their name to enter their exam during login. If the user enters incorrect information such as an invalid token number or incorrect spelling of the test taker's name, access will be denied. It will be appreciated that embodiments of the present disclosure operate without requiring the test taker to create an account and provide personal details to the system. In various embodiments, the system only collects the first and last name of the test taker and can delete any record of such names upon completion or termination of the exam.

On each of the proctor and accommodator login screens, the user is prompted to login with two text boxes. For example, the user may be required to enter his or her email address in the first text box and a unique code provided as their “password”. If the user enters an invalid email address or password, access will be denied. In different embodiments of the present disclosure, a single individual acts as a proctor and as an accommodator, and in such embodiments, a single device (e.g., 16 or 18) can be employed by such individual. In various embodiments, a separate proctor overseeing device is in communication with the network 15 and provided with a visual display indicating how a test taker or test takers are being treated by the proctor and/or accommodator during examination. Such a visual display can be a video image or images of the proctor and/or accommodator such as may be recorded by a camera positioned within the environment of the proctor and/or accommodator and including the proctor and/or accommodator and optionally the proctor's and/or the accommodator's display screen. Such a visual display for the proctor overseeing device can further be a copy of the visual display of the proctor's or the accommodator's device, for example.

Once the user has successfully logged in, he/she will arrive at a landing page which may contain information for the exam as well as several selectable options. In various embodiments, the test taker's exam information will be displayed on the user interface, including the title of the exam, the date of the exam and the start time and end time of the exam. The test taker's name may appear along with exam taking instructions, such as “please check-in 30 minutes before the exam starts.” In various embodiments, a selection button can also be provided for the user to initiate exam check-in procedures. In various embodiments, the landing page can provide multiple links the user can employ to test his/her device to see if the device has all the requirements to use the application. By selecting a suitable link, a pop-up window can be displayed showing icons and a status bar as the test completes, for example. The icons can represent the user's device camera, microphone and bandwidth testing. In embodiments, a status bar is provided as a circle which will fill up in green as each component is confirmed. Once the system test completes, the user may be presented with a green tick or a red cross next to each of the three icons confirming it is sufficient or not sufficient. The user can close the window at any time.

It will be appreciated that before, during or after the check-in process, the user can be prompted by the system of the present disclosure to select a location and/or preferred language for communication and further processing. For example, a user may select “Brazil” as a location and “Portuguese” as a language in order to obtain access to documentation in Portuguese and potentially an accommodator and/or proctor fluent in Portuguese. The user's location may also be determined through geolocation processes via the user's computing device, where available and permitted.

In various embodiments, the user interface can provide instructions to the user with a checklist of items to complete before check-in and can further provide selections through which the user may customize his or her display according to the user's preferences.

In various embodiments, the check-in process is broken down into six stages and is separate to the exam environment. Once check-in has begun, the user may be presented with an interface such as a pop-up window titled “Welcome to REMOTEi” with text to introduce the user to the login experience. Optionally, this is also read out to the user with the computing device's audio output. The introduction can be provided with multiple screens, such as an introduction screen, a rules screen providing rules for using the application; a instructions screen indicating where to locate the application's connect button for assistance and an explanation screen providing explanation of what the check-in steps will include, for example.

The first stage of the check-in process can include a security permissions process advising the user of the type of information collected and who may use it. A link can be provided in the user interface which, upon user selection, opens a privacy statement in a pop-up window, for example. Once ready, the user can select a check box or otherwise interact with the user interface to confirm their agreement with the terms and proceed.

The second stage of the check-in process can include a system check process exemplified whereby the user's hardware and internet connection are checked to verify that they have the minimum necessary requirements to use the application. Optionally, this process may check for a webcam, audio input and output and may check that the bandwidth is strong enough to maintain a video call between the parties. In various embodiments, the user can be presented with the same interface as the system test described above. Once each item is confirmed, the status bar will be shown as complete and the user can proceed to the next stage. It will be appreciated that, at all stages during the check-in, the user will be provided with a way to “go back” and return to the previous screen as well as to exit the application. In various embodiments, prior to exiting the application upon receiving an indication that the user wishes to exit, the system can prompt the user with a warning asking if the user is sure they want to quit the application. If the user confirms, the system removes the user from the check-in process.

If the user has not previously provided permissions for the application to use their video and audio input as well as screen sharing, the user's operating system can provide an interface such as a pop-up message for the user to confirm the desire to grant the REMOTEi™ client application access to these items. In various embodiments, if access is denied, the user will not be able to proceed with the check-in process.

The third stage of the check-in process permits the user to share the user's screen. Sharing a screen permits the accommodator (16 in FIG. 1) with access to view the user's screen for the purpose of testing. In various embodiments, the system operates so as to blur out the proctor's screen so that the proctor cannot see the exam taker's screen. This is done to protect the privacy of the test taker while sitting for their exam while still allowing for the test taker's accommodator to assist. For example, if the test taker requires an accommodator to read the test to the test taker or input the test taker's answers and/or make selections, such an accommodator will need to see the screen. The proctor (18 in FIG. 1) will still monitor the test taker's screen in the event that the test taker minimizes their screen and attempts to use an unapproved application, for example, and the blurred screen images for the proctor will not detract from this purpose. Thus, it will be appreciated that, during an exam, the test taker and accommodator may view the test taker's screen fully and clearly while a proctor may see only a blurred version of part or all the test taker's screen. It will further be appreciated that each of the test taker, accommodator and proctor are likely to be in different physical locations during the check-in and exam taking processes. In various embodiments, the proctor and/or the accommodator can run the full examination for the test taker, including entering input into a device corresponding to the test taker's answers and managing the exam process as the test taker advances and/or returns to different portions of the exam.

To commence screen sharing, the user can interact with the user interface in a variety of ways, including by selecting a screen icon permitting screen sharing, for example.

The fourth stage of the check-in process is an identity check used to confirm the identity of the test taker. The identity check process simulates what would ordinarily be required if a test taker were physically checking in to a testing site in person, whereupon the test taker would be required to provide a valid photo identification to verify his or her full name and face. In the simulated identity check, the test taker can be presented with a user interface such as an interface showing two boxes reflecting the user's webcam image in real time. Underneath each box is a button with the text “Take Photo”, for example. Such boxes may be presented one at a time, and as the user completes the first photo, the second button will become available. The first photo can be used as a photo of the test taker to store with the recording of the exam. This is done to ensure that the person taking the exam is the same as the one who completes check-in. The second photo can present an open box in which the test taker must present their physical identification such as a driver's license or passport. This photo will store the user's identification for review before and after the exam. This photo can be flipped if the user takes it with a front-facing camera as the text will be reversed. Once completed, the user will be able to submit the photos such as by selecting an icon or button on the user interface. The user's photo(s) and any other identification information, including login information, can be considered user credentials.

It will be appreciated that capturing a photo of the test taker who will be sitting the exam can be verified through a current and valid State ID, such as a driver's license, to ensure that the person sitting the exam matches the one provided by the client. This can be checked by the proctor and verified during check-in as well as being stored with the report at the conclusion of the exam to be checked later if a dispute is raised. The proctor can complete the face and identity check process with the accommodator as well to verify that the accommodator helping the test taker, who has access to the exam content, will not be able to sit this exam at a later date until a prescribed time has passed, for example.

Once the user finishes the identity check process, the user can be taken to the fifth stage of the check-in process to meet the proctor who will be proctoring the exam. At this stage, the user will complete the check-in with the exam's proctor. The user's photos may initially be displayed on the user interface as they were taken and a communications interface such as a “chat” panel will appear on the user's screen. In various embodiments, the chat panel appears on only a portion of the user's screen and leaves the user with the option to toggle their window and to exit. In various embodiments, proximate the chat section, the user interface will provide a small live video of the user and a message with text such as “Proctor will join when ready”. In various embodiments, the user will have a small text input bar at the bottom with an icon in the shape of a paper plane inside an orange circle next to it which can be used to send a text message to the proctor and/or accommodator, for example.

Once the above steps are completed, the accommodator can join and can meet the test taker, helping the test taker to finish the check-in process as needed. In various embodiments, the accommodator's video will appear in a box next to the test taker's video and each will have access to the text chat if they wish to use it as well. Once the proctor joins, the proctor's blank box will be replaced with a video of the proctor. After introduction, the proctor can proceed through the final steps of check-in with the test taker and accommodator. In various embodiments, the first step will require the Proctor to verify the photos and test taker identification. If one or more of the photos are blurry or unclear, the proctor can request the test taker to retake these photos. In various embodiments, a “Retake” icon or button is provided beneath each current photo to permit the user to re-take specific photos, which can be updated into the interface in real time.

Once the photos are accepted by the proctor, the test taker will then complete a 360-degree scan of the test taker's room. This will be done to verify that there is no one else in the room with the test taker, that they do not have a cell phone, open books or any other prohibited items for the exam. The test taker may need to pick up their webcam and rotate it around to complete this and when the proctor is satisfied, the proctor will confirm acceptance and proceed. In various embodiments, the test taker may be required to read and complete an oath to the proctor. This is a stage where, if required, the test taker can ask for the assistance of the accommodator. This oath may differ from exam to exam according to test requirements and testing providers, but this process confirms that the test taker will not be cheating or will otherwise be subject to disqualification or some other defined penalty. The video of the user reading and accepting the oath can be stored in database 22 in the event of any dispute after the exam.

Once the above steps have been taken and accepted, the proctor can remove himself or herself from the call and the test taker will be moved to a final user interface which may be called the “Ready for Exam” stage. In various embodiments, this page can display the rules of the exam to the test taker while they wait for the exam to be commenced. The test taker will still have access to the chat window, where the accommodator will remain in video chat with the test taker. It is at this stage that the accommodator will specify their role to the test taker and to confirm the test taker's preferences for the exam. This completes the check-in process for the test taker.

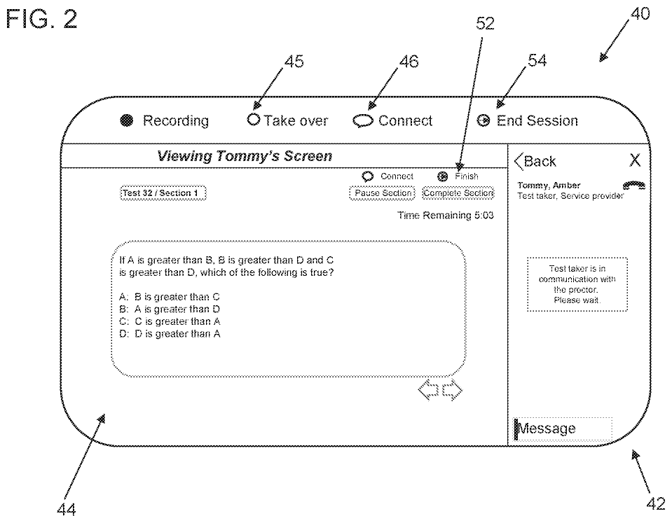

FIG. 2 shows an exemplary user interface 40 that may be presented to an accommodator after successful log-in. This user interface 40 may look and operate similar to the test taker's, and permits the accommodator to test his or her device for a pre-check as well as to permit the accommodator to begin the check-in process as described above in connection with the test taker.

The accommodator may receive the pop-up introduction, similar to that described for the test taker elsewhere herein, as the accommodator is introduced to the functions of the applications. The check-in process for the accommodator can operate as described above for the test taker and the accommodator may be asked to read and accept a privacy statement, confirm the physical requirements and share their screen. The accommodator's identification and photo or video can also be captured to verify that the accommodator (i.e., the person who will be assisting the test taker during the exam) is the same as the one assigned prior to the exam. These photos, like the test taker's, can be stored in database 22 and made available for review. The accommodator's photo(s) and any other identification information, including login information, can be considered accommodator credentials.

As with the test taker, the accommodator will meet with the proctor via a video chat and complete a 360-degree scan after the accommodator's face and ID photos or other proof of identification has been accepted. This is done with the accommodator to confirm that they are in a quiet room free of potential distractions so that they will not impact the test taker's exam. Once accepted, the accommodator is provided with an oath that they must read and accept, which is to confirm their requirements within the role with respect to the test taker and their access to sensitive information. Once completed, the proctor will leave the video call and they will remain waiting such as on a “Ready” screen for the test taker to begin their check-in.

Check-in for the proctor may proceed similarly. For example, the proctor may receive a pop-up introduction upon being introduced to the functions of the applications. The proctor can then complete the security and system check stages and allow the application access to their system. The proctor will then be required to submit his/her photo and ID to be stored with the recording to verify the identity of the proctor. The proctor will then read an oath to himself/herself and will have a way such as clicking an icon on a user interface to confirm his/her acceptance. The proctor will then be presented with a list of rules that he/she must comply with as a proctor during the exam to ensure that he/she understands his/her role and must accept to adhere to these before being able to proceed.

Once these steps have been completed, the proctor is presented with a button to permit check-in for the test taker and accommodator. Once selected, the check-in process is made available for the test taker and accommodator to check-in. The proctor will be taken to a dashboard which is akin to a waiting room before the exam. This is a separate environment to the exam and must be completed before the test taker will have access to his/her exam content. On this dashboard, the proctor can customize the screen appearance and is provided with the ability to exit the application such as via an “Exit” button. The proctor may also be provided with the ability to view exam rules for the specific exam being taken, including any instructions that the proctor will need to be aware of when facilitating the exam.

On one side of the screen, the proctor may be given a list of check-in steps they must complete with the accommodator and test taker independently which includes meeting the individuals, confirming their face and ID photos, a 360-degree scan of the environments in which the test taker and accommodator are present (e.g., the test taker's room and the accommodator's room) and to accept their oath. Once a test taker or accommodator logs into the application and begins their check-in, a display box may appear on the proctor's screen. Inside the box will be the name of the test taker or accommodator and their role in parenthesis, with a live video once such individuals complete the system check screen. Once these individuals have submitted their photos, the proctor may be provided with the ability to meet the other parties such as via a selectable button with the text “Meet”. The proctor can click this button to enter into a video chat with the test taker or accommodator. In various embodiments, only one can be completed at a time and the accommodator will generally be checked-in first. The proctor will have a similar screen as the accommodator or test taker including the chat panel on the right, such as shown at 42 in user interface 40. It will be appreciated that the arrangement of the live videos as recorded by the cameras associated with each user's computing device may be presented differently on each user's interface. For example, the live video of the proctor may appear at the top and the test taker/accommodator below. In various embodiments, the proctor will have an icon or selectable button to “Accept Photos”.

It is at this stage that if the proctor receives an unclear photo or if the accommodator/test taker has provided an invalid ID, the proctor can ask the appropriate party verbally to retake the photo. Once satisfactory photos are taken, the proctor can electronically accept the photos and advance to the 360-degree scan of the surrounding environment(s). It is the responsibility of the proctor to ensure that the room is empty of all prohibited items, other people and any potential distractions. The proctor also wants to ensure that the room is not too dark or too bright, that the other user is not sitting with their back to a light source or anything else that may interfere with the recording of the exam. Once completed, the proctor can require the accommodator/test taker complete his/her oath before accepting and proceeding.

After the proctor has checked in both the accommodator and test taker, the proctor will be able to open the exam. Only once the check-in has been completed will the proctor be presented with this option to ensure that the exam is not opened prematurely. Once this has been selected, the proctor will be given a set of rules to read to the test taker for this specific test. This will include total time, what the test taker can or cannot use as well as any other directions for the particular test. A set of icons with descriptions of the different notifications that may be sent can be displayed during the exam.

After the proctor has completed the explanation of the rules, the proctor can then open the exam environment. This will take the accommodator and test taker into the virtual exam room which contains a web-based exam. In various embodiments, the test taker's exam content and exam time will be linked to this web page but it will be accessed within the REMOTEi™ client application itself, unless otherwise required by the client. The proctor will remain in the exam dashboard which will again have two white boxes, one for the test taker with their video in it, and one for the accommodator which will only contain their name and role.

In various embodiments, if the proctor moves his/her cursor over the test taker's box on the dashboard, the proctor may be presented with multiple selectable options as follows:
Connect: This button can be used to connect with the test taker during the exam. If the proctor needs to advise them of anything, or warn them for potential breaches of exam rules, they can select this button. It will open the chat panel on the right side and the proctor can also choose to commence a video call with the test taker and accommodator. This can also be opened when the test taker sends a text message to the proctor or requests a video call within the exam.
Note: The proctor can leave notes throughout the exam for an outside party such as a test administrator to review in their report. These will be time stamped to record at what point in the exam that the notes were left. This might be where the test taker has experienced a technical issue and wants it documented or has spoken about something they wish to be noted on the exam. By selecting this option, the panel on the right of the screen will display a text box where the proctor can leave one or more notes.
Flag: The proctor can flag the test taker for breaches of rules, or warnings, with either a light flag (yellow) or a severe flag (red). In either event, the flag will be time stamped and stored within the report that is available at the conclusion of the exam. In various embodiments, the proctor can be provided with a text box under their selection to record details of the flag. This can be used to explain the type of breach and document any interaction. In embodiments, if the proctor leaves a severe flag, the proctor will also be prompted with a pop-up box asking if they wish to end the exam. Some breaches of exam rules may result in an automatic dismissal from the exam. As such, if the proctor selects this option, the test taker's exam will be ended and the proctor can provide a written explanation for the dismissal.

In various embodiments, the appearance of the test taker's screen can take up the entirety of the proctor's screen with exception of the chat, notes or flag panels, which can remain open. The test taker's screen and the test taker's video can be displayed in two boxes, with the larger being underneath the other in certain embodiments. The proctor can switch between the video and the screen as desired to maximize one or the other for better viewing. In various embodiments, if the test taker's screen is displayed, the proctor will see a blurred screen whereby the proctor can see the color and outline but will be unable to read any text or see which answer selections have been made. This is done to see if the test taker is using the REMOTEi™ client application or if they have selected a different application such as an internet browser or calculator that may not be permitted according to the rules of the exam being taken. The proctor can also minimize the test taker's screen which will return the proctor to the dashboard view.

It will be appreciated that the proctor can monitor the test taker's activity throughout the exam to ensure that they are not using any applications or materials that are forbidden for use in that specific exam. Where a test taker is provided with an accommodator to assist them, whether this is to read the exam content to the test taker or input their answers, for example, the proctor can monitor the activity and behavior of the accommodator as well. To ensure the integrity of the exam is maintained, the proctor will capture the identity of both the accommodator and the test taker during the check-in process as well as a recording of the exam should the recording need to be inspected later. As a result of having access to the exam content, the accommodator may be prevented from assisting or otherwise sitting for that exam or that exam type for a set duration after assisting the test taker. However, because the proctor is not monitored during the exam, the proctor's view of the test taker's screen is blurred according to the present disclosure so that the exam content is unreadable but the screen is visible enough that it can be determined if the test taker is using a different application and/or cheating.

In various embodiments, the proctor may be provided with a function to end an exam, such as a button in the user interface for his/her application. In the event that the test taker does not end the session and the proctor must close the exam, the proctor will be able to select this function. In various embodiments, selecting this function will provide a pop-up window with a text box to fill in the reason for ending the exam. When the exam is ended this way, or with a dismissal through a severe flag, the test taker's screen will become grey and a pop-up can appear to advise the test taker that the proctor has ended the exam.

According to embodiments of the present disclosure, the proctor is also be able to select an “options” function such as may be displayed as three horizontal dots in the user interface including the test taker display box. When the options function is selected, the proctor will be able to review the previously accepted Face and ID photos to ensure that the test taker who checked in is the same as the one sitting the exam. In the event that the test taker has requested and taken a break, the proctor can ensure that the person who returns is the same as the one who left.

Other types of functions and/or icons which may show up during an exam include:
Message Received: This may be presented as a colored circle with a number in the center that is displayed when a new text message is received. If the proctor hovers the cursor over the icon it can advise that there is a new message received. If the proctor selects this icon, the chat panel will open on the right side of the screen and the proctor will be able to see the chat history. The number in the center may increase for each new unread message, for example.
Video Request Received: This may be presented as a colored circle with a rectangle connected to a triangle in the middle, designed to look like a camera, which can be displayed when the accommodator requests a video with the proctor. In various embodiments, this can be displayed on the right side of the test taker's display box. If the proctor hovers his or her cursor over the icon, it can advise that the video request has been received and, if selected, it can open the chat panel and a video will commence with the accommodator and test taker.
Requested Break: This may be presented as a colored circle with an analog clock in the middle within the test taker's display box. If the proctor hovers his or her cursor over the icon, it can advise that a break has been requested and if clicked, it can provide a message to the proctor to approve or decline the requested break for the test taker.
End Session: This may be presented as a colored circle containing another colored circle with an arrow pointing to the right and displayed within the test taker's display box. This permits the test taker to request to end their exam session. When the proctor hovers his or her cursor over the icon, it can advise that the test taker has requested an end to the session and, if selected, can open the chat panel and a video will commence with the test taker and accommodator.
Additional Display Detected: This may be presented as a colored circle containing an exclamation mark or other icon and displayed within the test taker's display box. This will be displayed if the test taker has a second display connected to their computer. This is a warning to notify the proctor that one is in use, and if the display is disconnected the icon will disappear. In various embodiments, the proctor may communicate with the test taker, or may simply make a note of the instance of the second display. This can be done because the second display is not visible to the proctor and is not included in the recording of the exam.

Once the proctor has opened the exam, the test taker will be taken into the exam room. A chat panel can be provided on part of the screen where a live video of the test taker can be displayed alongside a video of the accommodator. The test taker is able to send and receive text chat messages and if the proctor joins the video call, the video of the proctor can be displayed along with the test taker's video. The test taker will have access to customize the screen as well as to end the session. A chat panel can also be provided with the exam content. It will be appreciated that the exam being taken is a web-based exam built into the REMOTEi™ client application which can show the exam content to the test taker. This may require the test taker to login with their details to access the exam.

Once the exam has begun, the test taker will be able to complete the exam with the assistance of their accommodator. The test taker can verbally request that the accommodator cease or recommence their role at any time, such as by invoking a function through the test taker's user interface including by voice or chat communication. For example, the system and/or the application 20 or media server 12 may receive a request from a test taker device to cease receiving instructions from an accommodator device as input to the online examination. This may occur, for example, if the accommodator has been given permission to enter the test taker's selections for answers to questions via the accommodator's computing device during the examination but wherein the test taker wishes to assume control of the input. It will be appreciated that the accommodator can remain in video chat with the test taker throughout the duration of the exam regardless of whether the test taker wishes to utilize them or not.

In various embodiments such as shown in FIG. 2, the accommodator's screen 40 will have a chat panel 42 and will see a copy of the test taker's screen 44. The test taker's screen appearance 44 on the accommodator's user interface 40 will be unblurred. The accommodator will be able to customize the appearance of the screen 40 such as by a toggle full screen button. The accommodator's screen 40 may also be provided with a function to request a video with the proctor as shown at 46, for example. Such a function may be employed, for example, when a test taker requests the assistance of the exam administrator and/or proctor and for the accommodator to call the proctor to attend to the request. In various embodiments, this function 46 sends a notification to the proctor who can then join a video call or text chat to discuss any questions or issues. According to various embodiments, the accommodator can end a session by invoking a function as at 54 and such action may be invoked if, for example, the test taker becomes ill during an exam or if the test taker is flagged or being flagged by the accommodator, for example.

It will be appreciated that the accommodator may have different roles depending on the needs of the test taker. The accommodator may be someone who will read exam content, a foreign language or sign language interpreter, a recorder that will input answers and operate the mouse and keyboard, or someone executing a combination of roles. For roles that involve a recorder that may be required to operate the controls for the test taker, the accommodator may be provided with a function such as may be implemented via an icon or selectable button as indicated at 45 to effectively take control of the test taker's screen. This will allow the accommodator to take control of the test taker's mouse and keyboard to input exam answers and make selections with the mouse, for example. Once this button is selected, the test taker will receive a notice such as via a pop-up window advising that the accommodator has requested control of their computer, with an option to allow or disallow. If the disallow option is selected, the pop-up will disappear and no access will be granted. If access is allowed or no option is selected within the time frame provided, then access will be granted to the accommodator according to embodiments of the present disclosure.

The accommodator with control of the test taker's computer can also be provided with the option to stop control of the test taker's computer, such as at the conclusion of the exam, or if the test taker requests to take control back for themselves. In various embodiments, the accommodator will only have access to the test taker's application to follow the directions given by the test taker during the exam. If the test taker exits the application, then the accommodator will no longer have access to the test taker's mouse and keyboard.

According to embodiments of the present disclosure, the test taker will also have the option to request a break via a function such as a selectable button on the user interface. By selecting the break button, the test taker will prompt the proctor to approve or deny a break, which will be dependent, for example, on whether or not a break is allowed per the exam rules. If approved, the system operates to obscure the exam content such as by overlaying the exam content with a black screen, for example, so that the test taker will be unable to see or make entries into the exam. In such instance, the test taker will still have access to a chat panel on the screen. Once the test taker returns from a break, the test taker will be able to resume the exam and the test taker's screen will return to the unobscured exam content.

When the test taker is ready to end the exam, the test taker can select a function such as a “finish” button on the screen (shown at 52 in FIG. 2 in the accommodator's screen 40). This will notify the proctor, who will then join the video call to discuss with the test taker. The proctor will confirm the exam is finished or the test taker is ready to leave and once confirmed they will approve the finish or “end session” function. In various embodiments, this will provide a pop-up message on the accommodator's screen 40 such as “The Test Taker has ended the exam” optionally with a “continue” function and/or button to advance. The test taker's screen may be instructed to show a pop-up message that “The Exam has ended” at which point both the test taker and accommodator can be taken to a review screen where they can leave feedback about the application. At this stage, the test taker and accommodator can be taken to a page where they can optionally close and/or uninstall the REMOTEi™ client application from their computer.

Once the exam has been completed, the proctor can have a video chat with the test taker and the accommodator to confirm that the test taker has finished with their exam. The proctor can then approve the ending of the exam and dismiss the test taker and accommodator. In various embodiments, this will then take the proctor to a ‘Review and Submit Report’ page. This report will display any notes or flags left during the exam as well as a small description of the manner in which the exam finished, for example, by dismissal due to a severe flag, that the test taker left and did not return or that the exam ended by test taker request. The report can be submitted to an outside party and/or stored in database 22 and available for review. The proctor can then be taken to a review screen where the proctor can leave feedback about their experience with the REMOTEi™ client application. Whether leaving feedback or not, the proctor can then be taken to a page where they can close and uninstall the REMOTEi™ application from their computer.

Once the exam has completed and the participants have left the application, the participants will be unable to login again according to various embodiments. If a user reinstalls and uses the application for a second exam in the future, the permission approval will remain in their respective computers unless changed. In various embodiments, the user will not need to approve the security, system check and share screen options of the check-in process upon re-installation and re-use.

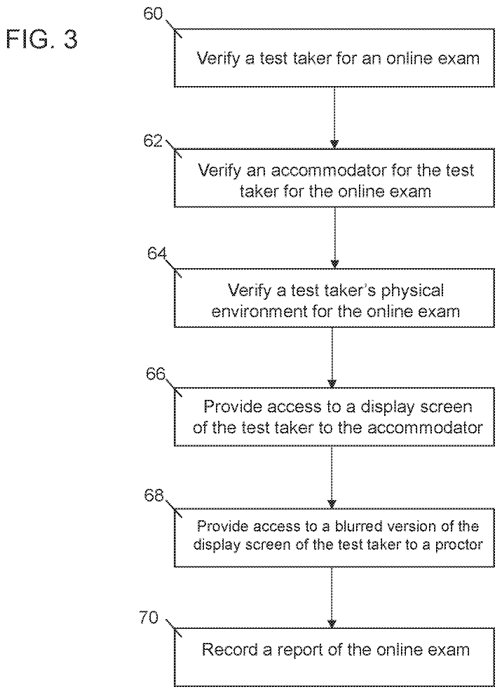

It will thus be appreciated that embodiments of the present disclosure provide, in part, a method, device and system for online proctoring of online exams. As shown in FIG. 3, a method according to the present disclosure can operate by verifying a test taker for an online examination as at 60, verifying an accommodator for a test taker for an online examination as at 62, verifying a test taker's physical environment for the online examination as at 64, providing access to a display screen of the test taker to an accommodator as at 66, providing access to a proctor for a blurred version of the display screen of the test taker as at 68 and recording a report of the online examination as at 70. The method can include additional functions as described elsewhere herein, or in various embodiments, may include fewer functions. A system and device consistent with the present disclosure can include a processor and stored instructions that, when executed by the processor, carry out the method as described above and shown in FIG. 3 as well as other functions as described herein.

Unless otherwise stated, devices, modules or components associated with the present disclosure that are in communication with each other do not need to be in continuous communication with each other. Further, devices, modules or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present disclosure include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random-access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present disclosure to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, satellite, EDGE and EVDO, for example. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

The present disclosure describes numerous embodiments of the present disclosure, and these embodiments are presented for illustrative purposes only. These embodiments are described in sufficient detail to enable those skilled in the art to practice the disclosure, and it will be appreciated that other embodiments may be employed and that structural, logical, software, electrical and other changes may be made without departing from the scope or spirit of the present disclosure. Accordingly, those skilled in the art will recognize that the present disclosure may be practiced with various modifications and alterations. Although particular features of the present disclosure can be described with reference to one or more particular embodiments or figures that form a part of the present disclosure, and in which are shown, by way of illustration, specific embodiments of the disclosure, it will be appreciated that such features are not limited to usage in the one or more particular embodiments or figures with reference to which they are described. The present disclosure is thus neither a literal description of all embodiments of the disclosure nor a listing of features of the disclosure that must be present in all embodiments.

The above-described embodiments of the present disclosure may be implemented in accordance with or in conjunction with one or more of a variety of different types of systems, such as, but not limited to, those described below.

The present disclosure contemplates a variety of different systems each having one or more of a plurality of different features, attributes, or characteristics. A “system” as used herein refers to various configurations of: (a) one or more remote servers (e.g., media server 12), central controllers, or remote hosts; and/or (b) one or more personal computing devices, such as desktop computers, laptop computers, tablet computers or computing devices, personal digital assistants, mobile phones, and other mobile computing devices, which may include a test taker device, an accommodator device and/or a proctor device. A system as used herein may also refer to: (c) a single central server, central controller, or remote host; and/or (d) a plurality of central servers, central controllers, or remote hosts in combination with one another; and/or (g) a plurality of personal computing devices which may include a test taker device, an accommodator device and/or a proctor device, for example, in communication with a central server, central controller or remote host.

In certain embodiments in which the system includes a central server, central controller, or remote host, the central server, central controller, or remote host is any suitable computing device (such as a server) that includes at least one processor and at least one memory device or data storage device. The processor of the additional device, central server, central controller or remote host is configured to transmit and receive data or signals representing events, messages, commands, or any other suitable information between the central server, central controller or remote host and the additional device.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented as entirely hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Per, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

1. A device for online proctoring of an online examination, comprising:
a processor; and
a computer-readable memory and program instructions encoded by the computer-readable memory for causing the processor, when executed, to perform steps comprising:
verifying a test taker for an online examination;
verifying an accommodator for a test taker for an online examination;
verifying a test taker's physical environment for the online examination;
providing access to a display screen of the test taker to the accommodator;
providing access to a proctor of the display screen of the test taker; and
recording a report of the online examination.

2. The device of claim 1, wherein providing access to the proctor comprises providing a blurred version of the display screen of the test taker.

3. The device of claim 1, wherein the instructions, when executed, further cause the processor to receive input for the online examination from the accommodator device.

4. The device of claim 1, wherein the instructions, when executed, further cause the processor to provide a video image of the test taker to the proctor or the accommodator.

5. The device of claim 1, wherein the instructions, when executed, further cause the processor to receive, from a proctor device, an approval for a test taker break and further cause the processor to obscure the online examination on a test taker device during the test taker break.

6. The device of claim 1 wherein the instructions, when executed, further cause the processor to receive a request from a test taker device to cease receiving instructions from an accommodator device as input to the online examination.

7. A method for online proctoring of an online examination, comprising:
verifying, by a media server, a test taker for an online examination;
verifying, by the media server, an accommodator for a test taker for the online examination;
verifying, by a proctor device, a test taker's physical environment for the online examination;
presenting a live video record of the display screen of the computing device of the test taker to a computing device of the accommodator;
presenting a version of the display screen of the test taker to a proctor device; and
recording a report of the online examination.

8. The method of claim 7, wherein presenting a version of the display screen of the test taker to a proctor device comprises providing a blurred version of the display screen of the test taker.

9. The method of claim 7, further comprising receiving input for the online examination from the accommodator device.

10. The method of claim 7, further comprising providing a video image of the test taker to the proctor or the accommodator.

11. The method of claim 7, further comprising:
receiving, from a proctor device, an approval for a test taker break; and
obscuring the online examination on a test taker device during the test taker break.

12. The method of claim 7 further comprising receiving a request from a test taker device to cease receiving instructions from an accommodator device as input to the online examination.

13. A system for online proctoring of an online examination, comprising:
a test taker device;
an accommodator device;
a proctor device;
a processor; and
a computer-readable memory and program instructions encoded by the computer-readable memory for causing the processor, when executed, to perform steps comprising:
receiving identification credentials from the test taker device for a test taker and from the accommodator device for an accommodator;
providing access to a display screen of the test taker device to a display screen of the accommodator device;
providing access to a version of the display screen of the test taker device to a display screen of the proctor device; and
receiving input for the online examination until the online examination is completed or terminated.

14. The system of claim 13, wherein providing access to a version of the display screen of the test taker device to the display screen of the proctor device comprises providing access to a blurred version of the display screen of the test taker device to the display screen of the proctor device.

15. The system of claim 13, wherein the instructions, when executed, further cause the processor to verify a test taker's physical environment for the online examination.

16. The system of claim 13, wherein the instructions, when executed, further cause the processor to receive input for the online examination from the test taker device.

17. The system of claim 13, wherein the instructions, when executed, further cause the processor to receive input for the online examination from the accommodator device.

18. The system of claim 13, wherein the instructions, when executed, further cause the processor to provide a video image of the test taker to the proctor or the accommodator.

19. The system of claim 13, wherein the instructions, when executed, further cause the processor to provide a video image of the proctor to a proctor overseeing device.

20. The system of claim 13, wherein the instructions, when executed, further cause the processor to receive, from the proctor device, an approval for a test taker break and further cause the processor to obscure the online examination on the test taker device during the test taker break.
